(19) United States
(12) Patent Application Publication
(10) Pub. No.: US 2017/0215649 A1
(43) Pub. Date: Aug. 3, 2017

(54) Combination Utensil Strainer

(71) Applicant: Angela Hughes, Austin, TX (US)

(72) Inventor: Angela Hughes, Austin, TX (US)

(21) Appl. No.: 15/422,531

(22) Filed: Feb. 2, 2017

Related U.S. Application Data
(60) Provisional application No. 62/290,304, filed on Feb. 2, 2016.
(60) Provisional application No. 62/340,249, filed on May 23, 2016.

(51) Int. Cl. A47J 43/28; G01F 19/00

(52) U.S. Cl. CPC A47J 43/288; G01F 19/002; A47J 43/281; A47J 43/284

(57) ABSTRACT

A system for a combination utensil and strainer tool. The tool has a utensil portion. Attached to and downstream from the utensil portion is the straining portion. Attached to and downstream of the straining portion is the handle portion. A user can use the utensil portion to stir, cook, and other functions. The user can thereafter use the same tool as a strainer.

### PRIORITY

The present invention claims priority to U.S. Provisional Application No. 62/290,307 entitled “Combination Utensil Strainer” and filed Feb. 2, 2016, the entirety of which is hereby incorporated by reference. The present invention also claims priority to U.S. Provisional Application No. 62/340,249 entitled “Combination Utensil Strainer” and filed May 23, 2016, the entirety of which is hereby incorporated by reference.

### BACKGROUND OF THE INVENTION

### Technical Field

The present invention relates to a system and method for a combination utensil strainer.

### Description of Related Art

Currently, when cooking, a utensil, such as a spoon, is used to stir ingredients. Consider a pan filled with boiling water and pasta. The spoon is used to stir the pasta. However, when it becomes necessary to drain the water, a separate tool, such as a strainer, is used to remove the water. The cook must retrieve a separate tool, return to the pot, and then drain the pot. Consequently, there is a desire to have a single tool which accomplishes both stirring and straining.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top view of the combination tool in one embodiment;

FIG. 2 is a side view of the combination tool in one embodiment;

FIG. 3 is a top view of a combination tool in one embodiment;

FIG. 4 is a bottom view of a combination tool in one embodiment;

FIG. 5 is a side view of a combination tool in one embodiment;

FIG. 6 is a bottom perspective view of a combination tool in one embodiment;

FIG. 7 is a top perspective view of a combination tool in one embodiment;

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

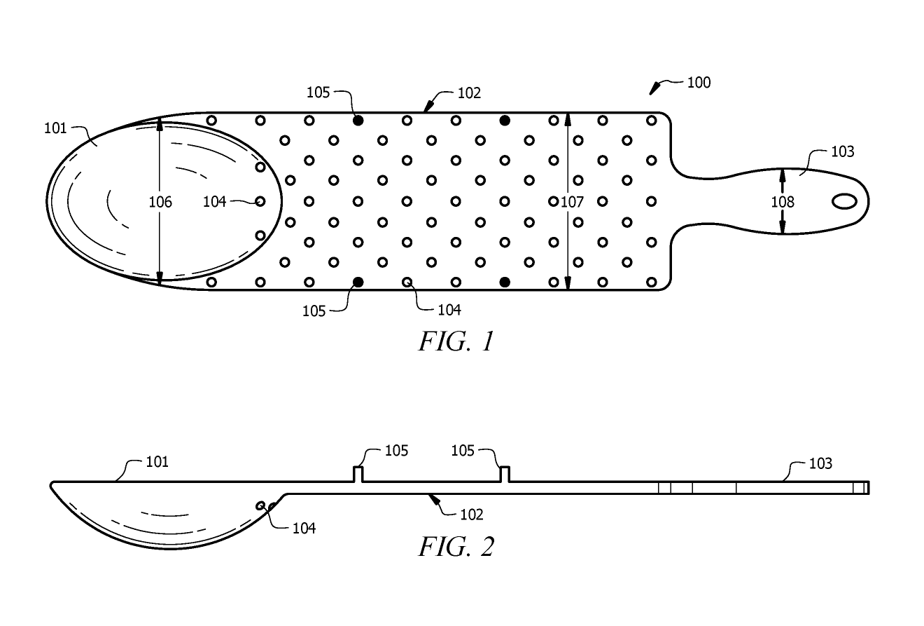

FIG. 1 is a top view of the combination tool in one embodiment. A combination tool, as used herein, refers a device which can be used as two or more tools for two or more differing objectives. In one embodiment the combination tool comprises a combination utensil and strainer.

As can be seen, in one embodiment the tool 100 comprises a handle 103, a strainer portion 102, a utensil portion 101, and at least one drain hole 104. These will be discussed in detail below.

The tool 100 can comprise virtually any material. In one embodiment the tool 100 comprises plastic, metal, wood, rubber, and combinations thereof. The tool 100 can comprise virtually any material used in kitchen tools. The tool 100 can comprise a single piece integrally made, or the tool 100 can comprise two or more pieces coupled together.

The utensil portion 101 can comprise virtually any common utensil, and includes, but is not limited to, a spoon, a knife, a salad prong, pasta grabber, etc. A utensil, as used herein, is a household object which is used to cook or transfer food. While a spoon will be discussed, this is for illustrative purposes and should not be deemed limiting.

Considering a spoon, the spoon can be solid or it can be slotted, or the equivalent. A solid spoon is a spoon which will hold a liquid whereas a slotted spoon is a spoon which will allow fluid to pass through one or more openings.

The utensil portion 101 can have a varying length, depending upon the application. The length, as measured along the largest axis traveling between the spoon portion and the handle portion 103 can vary from about 0.5 inches to about 6 inches. The maximum utensil width 106, which is perpendicular to the length, can vary from about 0.5 inches to about 5 inches.

As depicted, the utensil 101 comprises a rounded upstream portion. As used herein, upstream and downstream will refer to various locations on the tool 100. A part closer to the utensil portion 101, the left side of the figure as depicted, is upstream whereas the handle 103, as depicted, is downstream. Thus, as depicted, the furthest upstream portion of the tool 101 comprises a rounded edge. As depicted, the width of the utensil portion 101 increases along the curve until it terminates at the maximum utensil width 106.

Coupled to the utensil portion 101 is the straining portion 102. As depicted, the straining portion 102 is downstream of the utensil portion 101. Liquid can pass through one or more drain holes 104. The drain holes 104 are holes, voids, openings, or channels in the straining portion 102. In one embodiment the drain holes 104 extend completely through the straining portion 102 such that liquid can pass from a front side through a drain hole 104 and exit through the drain hole 104 through the rear side of the tool 100.

As noted, the drain holes 104 can comprise one, or in other embodiments, a plurality of holes 104 located on the straining portion 102. Accordingly, in one embodiment the straining portion 102 comprises a solid structure which has holes located thereon. In other embodiments, however, the straining portion 102 comprises a mesh or other similar structure which allows a liquid to pass through the straining portion 102. The straining portion 102 can comprise any holes, mesh, fabric, etc. which allows liquid to pass but which presents food particles from passing.

The length of the straining portion 102 can vary depending upon the desired application. In one embodiment the straining portion 102 has a length of about 2-12 inches. In other embodiments the straining portion 102 has a length of between about 4-8 inches.

The straining portion 102 comprises a maximum straining width 107. The maximum straining width 107 can vary from about 1 inch to about 6 inches. In one embodiment the width 107 ranges from about 2 to about 4 inches. In one embodiment the straining portion 102 has an approximately uniform width 107. In one embodiment the straining portion width 107 is approximately the same as the maximum utensil width 106. In one embodiment the straining portion 107 is within 25% of the maximum utensil width 106. The maximum straining width 107 can vary depending on the desired application. In one embodiment a larger straining width 107 provides an increased draining surface area. An increased draining surface area provides, in one embodiment, for safer draining and often faster draining.

Downstream of the draining portion 102 is the handle portion 103. The handle portion 103, in one embodiment, has a maximum handle width 108. In one embodiment, and as depicted, the maximum handle width 108 is less than the maximum straining width 107.

The handle portion 103 serves as a handle and allows the user to grasp and control the tool 100. As depicted, the handle 103 comprises a hole which allows the tool 100 to be hung from a hook, loop, etc.

FIG. 2 is a side view of the tool in one embodiment. As can be seen, in one embodiment the utensil portion 101 extends downward below the planar surface of the straining portion 102. As shown in FIG. 2, in one embodiment the combination tool has a side profile which resembles a traditional utensil.

As depicted, and in one embodiment, the straining portion 102 comprises one or more pegs 105. As shown in FIGS. 1 and 2, the tool 100 comprises four pegs 105: a pair on the left side of the tool 100 and a pair on the right side of the tool 100. In one embodiment, and as shown in FIG. 1, there is one pair of pegs 105 upstream and one pair of pegs downstream. As depicted the pegs are on opposing sides of the width of the tool, but this is for illustrative purposes only and should not be deemed limiting. As can be seen in FIG. 2, the pegs 105 extend upward beyond the planar face of the straining portion 102. In one embodiment, the pegs 105 can be screwed, soldered, welded, or otherwise attached to the tool 100. In other embodiments the pegs 105 are integrally made as a single piece with the straining portion 102.

As noted, the pegs 105 stick outward beyond the planar face of the straining portion 102. In operation, the pegs 105 provides a support or lip upon which a pot or pan can be rested when utilizing the straining portion 102. This will be discussed in more detail below. In one embodiment the pegs comprise cylindrical knobs which extend beyond the planar face of the tool. Thus, in one embodiment, the pegs stick outward to allow a pot or pan to be engaged and locked in place adjacent to the pegs 105. In this manner, the pegs 105 offer increased safety during straining as it keeps or maintains the pot or pan in a desired location adjacent and relative to the combination tool.

Now that the tool 100 has been described, the use of the tool 100 in one embodiment will now be described. The use will be described in reference to a pot of pasta, however this is for illustrative purposes and should not be deemed limiting.

If a user of the tool 100 is desiring to cook macaroni and cheese, for example, the user will first bring a pot of water to a boil. Thereafter, the macaroni will be deposited into the pan and cooked for a period of time. During the cooking, the user must stir the macaroni to prevent it from clumping or otherwise sticking to the pot. To do this, the user will grasp the handle 103 and insert the utensil portion 101 into the spot. The user will utilize the utensil portion 101 to stir the macaroni.

After the necessary cooking step, the user must next drain the water from the pot. Previously, this required the user to retrieve a colander or other separate straining device. However, with the tool 100 discussed herein, the user has no need to retrieve a separate tool 100 and instead can use the same tool 100 used for stirring.

The user will bring the pot to a sink, for example, which will receive the drained liquid. The user can position the face of the straining portion 102 to cover a portion of the pot. When the pot is positioned at an angle, water will flow through the openings 104 of the straining portion 102. However, only the water will be allowed to pass through the openings 104; the straining portion 102 will retain the macaroni within the pot. In one embodiment, the handle 103 will be positioned slightly above the utensil portion 101 to prevent hot liquid from draining onto the user's hand. In one embodiment the downstream portion of the strainer 102 comprises a raised portion which functions as a guard against hot liquid draining onto the handle and burning a user's hand.

As noted, in some embodiments the straining portion 102 comprises pegs 105. These pegs 105 engage with the pot to keep the pot in proper alignment and engagement with the tool 100. Often only two hands are available to strain the pot. The user holds the pot with one hand and the handle 103 with the other hand. The pegs 105 helps the tool 100 to secure and engage the pot, aiding in the ease of draining.

Once draining is complete, the tool 100 can be removed and the pot can be placed back on a horizontal surface. Thereafter, if additional ingredients are needed, such as milk and cheese with the macaroni, the tool 100 can once again be used as a stirring utensil. Once the necessary ingredients have been added and stirred, the utensil portion 101 can be used to serve the macaroni.

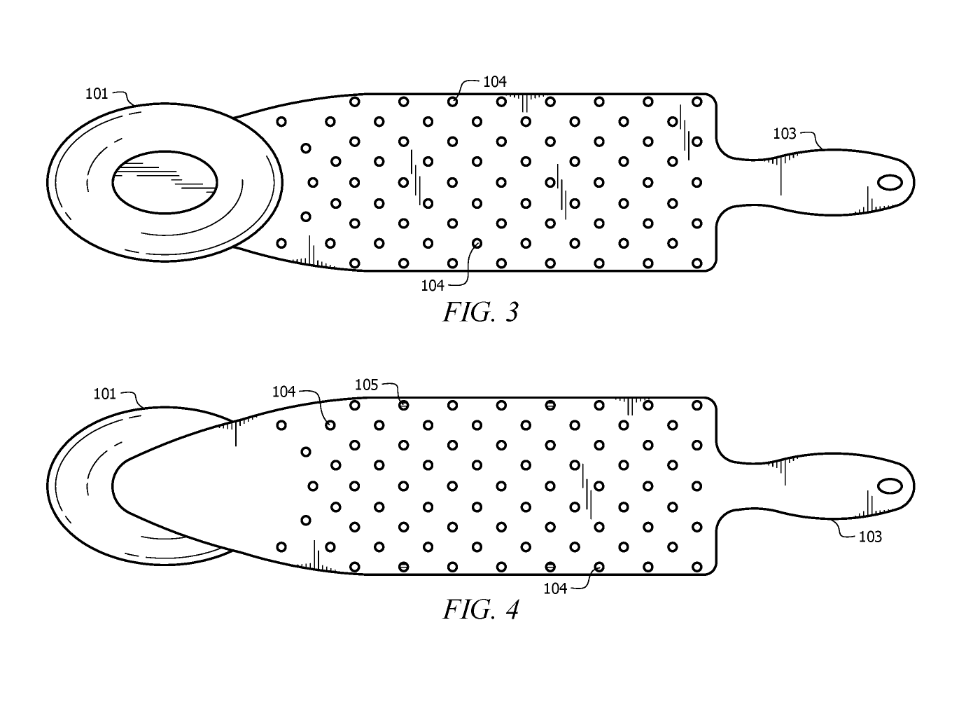

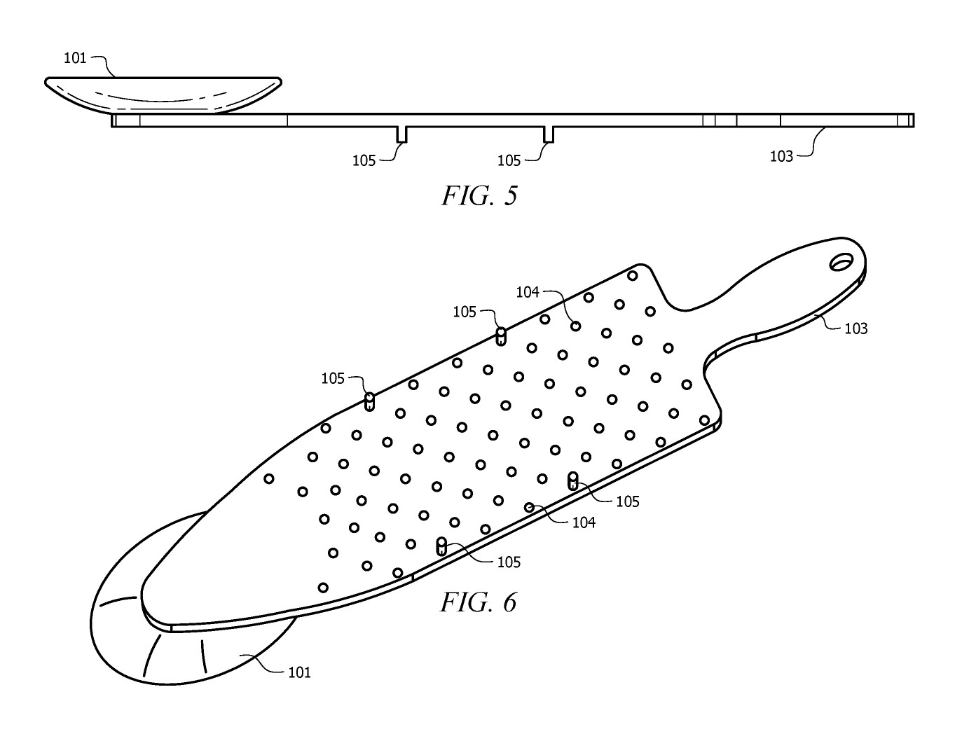

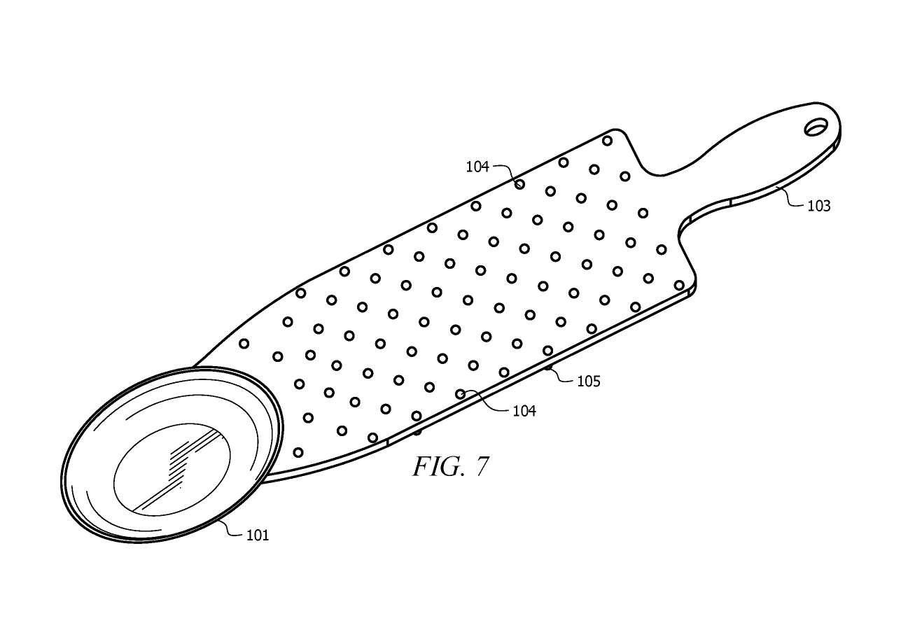

While one embodiment wherein the pegs 105 are located on the top side has been described, this is for illustrative purposes only and should not be deemed limiting. In one embodiment the pegs 105 are located on a bottom side. Turning now to FIGS. 3-7, these figures depict an embodiment wherein the pegs 105 are located on a bottom side. FIG. 3 is a top view of a combination tool in one embodiment. FIG. 4 is a bottom view of a combination tool in one embodiment. FIG. 5 is a side view of a multi-tool in one embodiment. FIG. 6 is a bottom perspective view of a combination tool in one embodiment, and FIG. 7 is a top perspective view of a combination tool in one embodiment;

As can be seen in FIG. 3, the tool 100 is similar to the tool in FIG. 1 but the pegs 105 are located on the bottom side. Referring to FIG. 5, it can be seen that the pegs 105 are located on the back side. In such embodiments the tool 100 can be placed upon the pegs 105 such that the tool 100 rests upon the pegs 105. This has the benefit of keeping the utensil portion 101 off of the counter, for example. Consider using the utensil portion 101 to stir spaghetti sauce. Previously, after stirring the utensil would be placed upon a utensil holder, a paper towel, a plate, etc., to keep the sauce of the utensil from touching the kitchen counter, for example. The plate upon which the stir spoon rests would then also have to be washed after cooking. The pegs 105 being located on the bottom of the tool 100 eliminates the need for a separate tool, plate, etc. upon which the utensil portion 101 can rest. Accordingly, one benefit is the ability to eliminate an additional tool which may be washed. A second benefit is keeping the cooking surface clean and free from the sauce, for example. A third benefit is sanitation purposes because the utensil portion 101 is raised such that it does not come into contact with the cooking surface, such as a counter.

In one embodiment the utensil portion 101, comprises a solid measuring area. As used herein, a solid measuring area refers to an area within the utensil portion 101 which holds and retains a measured allotment of a solid or liquid. In one embodiment the solid measured area does not comprise holes which would allow its contents to drain. Put differently, in one embodiment, when contents are placed within the solid measuring area, the contents will remain until poured out from the solid measuring area. In this fashion, the measured area can serve as a measuring cup. As but one non-limiting example, in one embodiment the utensil portion 101 comprises a solid measuring area holding ¼ cup of an ingredient. The measuring area, in one embodiment, is marked with a measuring line to which the ingredient must be filled to reach a desired volume and/or weight. In one embodiment, the measuring area comprises one or more markings or demarcations whereby two dissimilar measured areas are indicated. Thus, in one embodiment the measuring area comprises two or more measuring lines. As an example, a single utensil can include one measuring line, such as demarcation, showing ¼ of a cup and a second measuring line, such as a demarcation, showing ½ of a cup. When cooking, flour, as an example, can be added to the measuring area in a desired amount of ¼ cup. Thus, if a recipe calls for ¼ cup of flour and ½ a cup of sugar, the tool 100 can be used to measure and dispense the various ingredients. This is yet an additional elimination and reduction of a tool, such as a measuring cup, which now is not required. Thus, the single combination tool 100 serves as a function of a stirrer, utensil, strainer, and measuring cup. As noted herein, this eliminates the need to acquire and keep separate tools, reduces the amount of tools which must be washed after cooking, and reduces wasted trips to the cabinet to retrieve redundant tools. The tool 100 described herein can be used in a variety of fashions.

As can be seen, the tool 100 described herein has many advantages. First, a single tool can be used to both stir, serve, prepare, and strain. This eliminates the need to retrieve a second tool such as a separate colander or strainer. Further, this eliminates the need to clean this second tool. Thus, only a single tool 100 will need to be cleaned as opposed to two or more separate tools.

Second, the combination of multiple tools into a single tool 100 eliminates the need to separate store multiple tools. When storage space is often at a premium, this is an advantage over the prior art.

Third, as noted, in one embodiment the maximum straining width 107 is approximately equal to, or is within 25% of, the maximum utensil width 106. This is an advantage because this allows the utensil portion 101 to function as a strainer as well. Further, this maximizes surface area by providing a comparatively increased straining area. Thus, the function is superior compared to a utensil which has a reduced neck and then flares outwardly again for the straining portion. As stated, increased straining area results in increased and more efficient straining.

Fourth, as noted some embodiments use pegs 105. These pegs 105 increase safety by providing a lip upon which the pot or pan can rest. This decreases the likelihood that a pan will slip or fall relative to the strainer, decreasing the chance that the user will accidentally burn themselves.

As noted, while a spoon has been described as the utensil, this is for illustrative purposes only and should not be deemed limiting. In other embodiments the tool 100 can comprise a fork, a knife, a serving spoon, a slotted spoon, salad prongs, pasta grabber, etc. Virtually any utensil which can be used in conjunction with straining can be utilized.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A combination tool comprising:
   a utensil portion;
   a straining portion coupled to and downstream from said utensil portion;
   a handle portion coupled to and downstream from said straining portion;
   wherein said straining portion comprises at least one hole.
Clause 2. The tool of any proceeding or preceding claim wherein said straining portion comprises a maximum width, and wherein said utensil portion comprises a maximum width, and wherein said straining portion maximum width is approximately equal to the utensil portion maximum width.
Clause 3. The tool of any proceeding or preceding claim further comprising at least one peg.
Clause 4. The tool of any proceeding or preceding claim further comprising at least two pegs.
Clause 5. The tool of any proceeding or preceding claim wherein said at least two pegs are located on a top side of the tool.
Clause 6. The tool of any proceeding or preceding claim wherein said at least two pegs are located on a bottom side of the tool.
Clause 7. The tool of any proceeding or preceding claim wherein said tool comprises at a first pair of pegs, and wherein said tool comprises a second pair of pegs, wherein said second pair of pegs is located downstream from said first pair of pegs.
Clause 8. The tool of any proceeding or preceding claim wherein said utensil portion comprises a solid measuring area.
Clause 9. The tool of any proceeding or preceding claim wherein said utensil portion comprises a first measuring line.
Clause 10. The tool of any proceeding or preceding claim wherein said utensil portion comprises a second measuring line, wherein said first and second measuring lines indicate two dissimilar volumes.
Clause 11. The tool of any proceeding or preceding claim which can be used as a strainer, a stirrer, and a measuring cup.
Clause 12. The tool of any proceeding or preceding claim wherein said utensil portion comprises a spoon.
Clause 13. The tool of any proceeding or preceding claim wherein said utensil portion comprises a fork.
Clause 14. A method of using a combination tool, wherein said combination tool comprises:
   a utensil portion;
   a straining portion coupled to and downstream from said utensil portion;
   a handle portion coupled to and downstream from said straining portion;
   wherein said straining portion comprises at least one hole;
   wherein said method comprises:
   a) using said utensil portion to stir a container holding a liquid and a food component;
   b) removing at least some of said liquid and retaining at least a portion of said food component using said straining portion.
Clause 15. The method of any proceeding or preceding claim wherein said combination tool comprises at least one peg, and wherein said removing of step b) comprises coupling said at least one peg to a container.
Clause 16. The method of any proceeding or preceding claim wherein said utensil portion comprises a solid measuring area and a first measuring line, and wherein said method further comprises filling said utensil portion with an ingredient up to said first measuring line.

What is claimed is:

1. A combination tool comprising:
a utensil portion;
a straining portion coupled to and downstream from said utensil portion;
a handle portion coupled to and downstream from said straining portion;
wherein said straining portion comprises at least one hole.

2. The tool of claim 1 wherein said straining portion comprises a maximum width, and wherein said utensil portion comprises a maximum width, and wherein said straining portion maximum width is approximately equal to the utensil portion maximum width.

3. The tool of claim 1 further comprising at least one peg.

4. The tool of claim 1 further comprising at least two pegs.

5. The tool of claim 4 wherein said at least two pegs are located on a top side of the tool.

6. The tool of claim 4 wherein said at least two pegs are located on a bottom side of the tool.

7. The tool of claim 4 wherein said tool comprises at a first pair of pegs, and wherein said tool comprises a second pair of pegs, wherein said second pair of pegs is located downstream from said first pair of pegs.

8. The tool of claim 1 wherein said utensil portion comprises a solid measuring area.

9. The tool of claim 8 wherein said utensil portion comprises a first measuring line.

10. The tool of claim 9 wherein said utensil portion comprises a second measuring line, wherein said first and second measuring lines indicate two dissimilar volumes.

11. The tool of claim 8 which can be used as a strainer, a stirrer, and a measuring cup.

12. The tool of claim 1 wherein said utensil portion comprises a spoon.

13. The tool of claim 1 wherein said utensil portion comprises a fork.

14. A method of using a combination tool, wherein said combination tool comprises:
a utensil portion;
a straining portion coupled to and downstream from said utensil portion;
a handle portion coupled to and downstream from said straining portion;
wherein said straining portion comprises at least one hole;
wherein said method comprises:
a) using said utensil portion to stir a container holding a liquid and a food component;
b) removing at least some of said liquid and retaining at least a portion of said food component using said straining portion.

15. The method of claim 14 wherein said combination tool comprises at least one peg, and wherein said removing of step b) comprises coupling said at least one peg to a container.

16. The method of claim 14 wherein said utensil portion comprises a solid measuring area and a first measuring line, and wherein said method further comprises filling said utensil portion with an ingredient up to said first measuring line.
